(19) United States
(12) Patent Application Publication
(10) Pub. No.: US 2021/0278545 A1
(43) Pub. Date: Sep. 9, 2021

(54) OBSTACLE DETECTOR OF CONSTRUCTION VEHICLE

(71) Applicant: SAKAI HEAVY INDUSTRIES, LTD., Tokyo (JP)

(72) Inventors: Ryohei ENDO, Saitama (JP); Norio MORIOKA, Saitama (JP)

(21) Appl. No.: 17/192,848

(22) Filed: Mar. 4, 2021

(30) Foreign Application Priority Data
Mar. 5, 2020 (JP) 2020-037994

(51) Int. Cl. G01S 17/931; B60W 50/00; G01S 17/04

(52) U.S. Cl. CPC G01S 17/931; B60W 2050/0083; G01S 17/04; B60W 50/00

(57) ABSTRACT

An obstacle detector mounted on a construction vehicle to detect an obstacle includes an operation controller. The operation controller includes: a trigger detection unit which detects an alteration trigger as a trigger to alter an obstacle detection range in a width direction of the construction vehicle; and an alteration unit which alters a normal detection range, which is the obstacle detection range during normal operation, to a predetermined altered detection range, which is an obstacle detection range after alteration, when the alteration trigger is detected at a time of operating with the normal detection range

### CROSS REFERENCE TO RELATED APPLICATIONS

The present application claims the benefit of priority to Japanese Patent Application No. 2020-037994 filed on Mar. 5, 2020, the disclosures of all of which are hereby incorporated by reference in their entireties.

### BACKGROUND OF THE INVENTION

### Field of the Invention

The present disclosure relates to an obstacle detector of a construction vehicle.

### Description of the Related Art

There has been a device to detect obstacles around a construction vehicle such as a compactor. Japanese Patent Application Publication No. 2019-12394 discloses an obstacle detector as one of obstacle detectors to be mounted on a construction vehicle. The obstacle detector mentioned above includes: a distance image sensor of a Time-of-Flight (TOF) type which measures a distance based on a time difference between projected light and reflected light; and a controller which determines presence or absence of an obstacle based on measurement data of the distance image sensor (see claim 1 of Japanese Patent Application Publication No. 2019-12394).

### BRIEF SUMMARY OF THE INVENTION

The obstacle detector described above has a fixed detection range in a width direction of the construction vehicle, regardless of a condition around the construction vehicle (see paragraph 0022 of Japanese Patent Application Publication No. 2019-12394). Therefore, for example, when the construction vehicle is pulled over to a wall or the like, the obstacle detector may detect the wall, and there is room for improvement in operability of the construction vehicle.

The present disclosure provides an obstacle detector of a construction vehicle with improved operability of a construction vehicle.

An obstacle detector of a construction vehicle of the present disclosure is an obstacle detector which is mounted on a construction vehicle to detect an obstacle and includes an operation controller including: a trigger detection unit which detects an alteration trigger as a trigger to alter an obstacle detection range in a width direction of the construction vehicle; and an alteration unit which alters a normal detection range, which is the obstacle detection range during normal operation, to a predetermined altered detection range, which is an obstacle detection range after alteration, when the alteration trigger is detected at a time of operating with the normal detection range.

The present disclosure provides an obstacle detector of a construction vehicle having improved operability of a construction vehicle.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a plan view of a construction vehicle mounted with an obstacle detector of a first embodiment;

FIG. 2 is a side view of the construction vehicle in FIG. 1;

FIG. 3 is a block diagram of the obstacle detector;

FIG. 4 is a schematic diagram of a hydraulic circuit of a rolling system including a brake device;

FIG. 5 is a plan view of the construction vehicle detecting obstacles with an altered detection range;

FIG. 6 illustrates detection in a normal detection range at a time of pulling over to a wall;

FIG. 7 illustrates v detection in the altered detection range at the time of pulling over to the wall;

FIG. 8 is a plan view of the construction vehicle of a second embodiment; and

FIG. 9 is a plan view of the construction vehicle mounted with an obstacle detector of a third embodiment.

### DETAILED DESCRIPTION OF THE INVENTION

Hereinafter, a description is given of embodiments to implement the present disclosure. Note that the present disclosure is not limited to the following description and illustration in the drawings and may be appropriately modified and implemented within a range where effects of the present disclosure are not significantly degraded. The present disclosure may be implemented by combining separate embodiments. In the following description, the same members are denoted by the same reference symbols in separate embodiments, and duplicate descriptions thereof are omitted. Further, the same terms are used for members having the same function, and duplicate descriptions thereof are omitted.

### First Embodiment

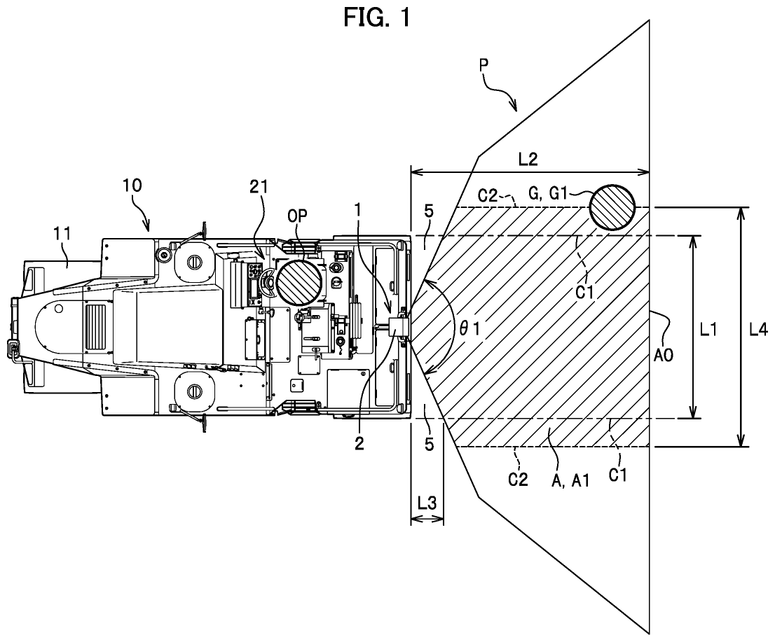

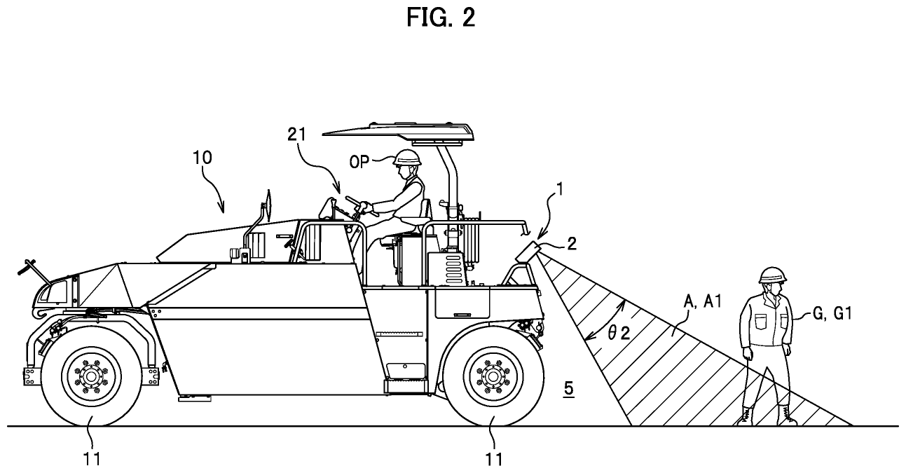

FIG. 1 is a plan view of a construction vehicle 10 mounted with an obstacle detector 1 of a first embodiment. Further, FIG. 2 is a side view of FIG. 1. The construction vehicle 10 is driven by an operator OP. The operator OP drives the construction vehicle 10 by operating a steering wheel, switches, buttons, or the like, for example. Further, the construction vehicle 10 is mounted with an operating device 21, though a detail thereof will be described below, for altering an obstacle detection range A. The operating device 21 is attached to a portion of the vehicle easily operated by the operator OP. Specifically, in the example of FIGS. 1 and 2, the operating device 21 is attached near the steering wheel.

The obstacle detector 1 is mounted on the construction vehicle 10 such as a compactor, rolling at a low speed, which rolls an asphalt road or the like with tire drums 11. The obstacle detector 1 detects an obstacle G within an obstacle detection range A. The obstacle G is a person G1 or a structure, for example. The structure includes fixed structures such as a wall G2 to be described below, buildings, columns, curbs, fences, movable structures such as movable walls, movable fences, and color cones (registered trademark), and other vehicles. During normal operation, the obstacle detector 1 detects the obstacle G within a normal detection range A1 as the obstacle detection range A.

The obstacle detector 1 includes a distance image sensor (three-dimensional distance sensor) 2 of a TOF type which measures a distance based on a time difference between projected light and reflected light. The distance image sensor 2 detects the obstacle G within the obstacle detection range A. Further, the distance image sensor 2 of a TOF type accurately measures a distance from the distance image sensor 2 to the obstacle G to improve accuracy of detecting the obstacle G. Further, there is no need to put detection tags on surrounding workers, as in a case of a detection method using radio waves, to contribute reducing a manufacturing cost of the construction vehicle 10. Still further, the workers are free from putting detection tags on, which improves accuracy of detecting the obstacle G. Yet further, the obstacle detection range A is easily set.

The distance image sensor 2 includes, though not illustrated, a light projecting unit which projects light such as infrared rays and a light receiving unit which receives reflected light when the projected light has irradiated an object. A time, after the infrared rays are projected from the light projecting unit till the reflected light is received by the light receiving unit, is measured, to measure a distance to the obstacle G. A projection angle from the distance image sensor 2 has a lateral angle θ1 of 95° and a vertical angle θ2 of 32°, for example, and a projected cross section has a rectangular shape in a lateral direction. Image resolution is 64 pixels in the lateral direction and 16 pixels in the vertical direction, for example, which amount to a total of 1024 pixels.

The distance image sensor 2 is mounted on a rear portion of the tire drum 11 at the center in a width direction to project light diagonally downward in a backward moving direction. The diagonally downward projection allows the lateral angle θ1 of the projected light in a plan view to further be more than 95°. This shortens a distance L3 of a non-detected range 5, to allow for narrowing non-detected blind areas on both sides of a rear portion of the construction vehicle 10.

If a projection range P of the projected light is set to the obstacle detection range A as it is, accuracy of detecting the obstacle G may become excessively high, even though there is no risk of collision. Therefore, in the embodiment illustrated in FIGS. 1 and 2, the obstacle detection range A is set to be narrower than the projection range P. The obstacle detection range A in the present embodiment includes two ranges, which are a normal detection range A1 and an altered detection range A2 to be described below.

The normal detection range A1 is a detection range to be set when the structure such as a wall is not present around the construction vehicle, for example. The normal detection range A1 is a range defined by boundary lines C2 in the width direction and a boundary line A0 at a rear end in the projection range P. The boundary line A0 is the same as a boundary line at a rear end of the projection range P. Here, virtual reference lines C1 are set, which extend rearward from the side portions of the construction vehicle 10 in line with the side portions.

Ends in the width direction of the normal detection range A1 correspond to the boundary lines C2 set outside the virtual reference lines C1. The boundary lines C2 are not necessarily in parallel to the virtual reference lines C1, but those lines are set in parallel with each other in the present embodiment. In the illustrated embodiment, a dimension L4 in the width direction of the normal detection range A1 is equal to or less than a dimension in the width direction of the projection range P, and is equal to or more than a vehicle width dimension L1 of the construction vehicle 10.

The dimension L4 is set to be equal to or more than the vehicle width dimension L1, so that the obstacle G within the range defined by the virtual reference lines C1 and the boundary lines C2 is detected, in addition to those within the range defined by the virtual reference lines C1. This prevents the obstacle G from being caught by the construction vehicle 10. Especially, when the construction vehicle 10 is of a small model, many workers may be around the construction vehicle 10 so that there is a relatively high risk for the workers being caught by the construction vehicle 10. However, as in the present embodiment, the dimension L4 of the normal detection range A1 is set to be greater than the vehicle width dimension L1 of the construction vehicle 10 to further prevent the obstacle (worker) G from being caught.

The distance image sensor 2 measures the distance to the obstacle G. Therefore, it is possible to determine whether the obstacle G is present in the obstacle detection range A which is set to the vehicle width dimension based on measurement data for every pixel, particularly, the distance in the width direction between the distance image sensor 2 and the obstacle G. The determination is executed by an operation controller 50 to be described below. With the distance image sensor 2, the dimension of the obstacle detection range A (dimension L4 in the case of the normal detection range A1) is constantly secured in a longitudinal direction. A dimension L2 in the longitudinal direction of the vehicle of the obstacle detection range A is appropriately set in accordance with a normal rolling speed, and is set to about 3 meters in the present embodiment, for example.

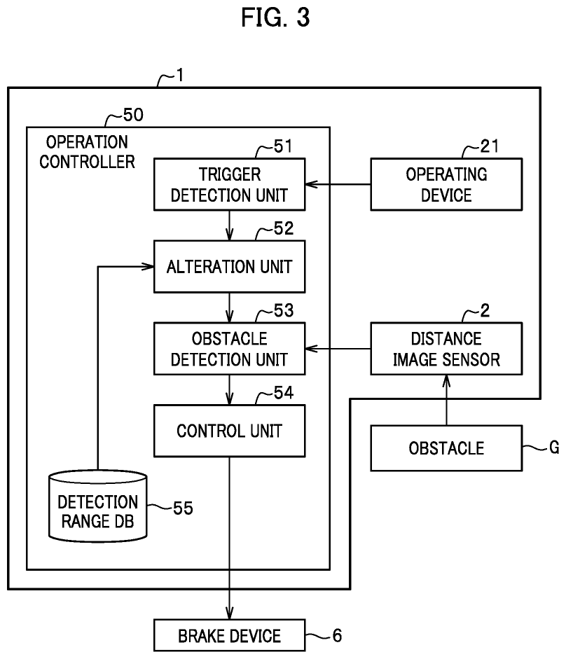

FIG. 3 is a block diagram of the obstacle detector 1. FIG. 3 illustrates the obstacle G and a brake device 6, in addition to the obstacle detector 1. The obstacle detector 1 includes the operation controller 50 and the operating device 21, in addition to the distance image sensor 2. When the obstacle G present in the obstacle detection range A or in the altered detection range A2 to be described below is detected, the operation controller 50 controls the brake device 6 to forcibly stop operation of the construction vehicle 10. Though details are described below, a trigger for altering the obstacle detection range A is input via the operating device 21 to the operation controller 50.

At first, for convenience, a rolling system of the construction vehicle 10 including the brake device 6 is described.

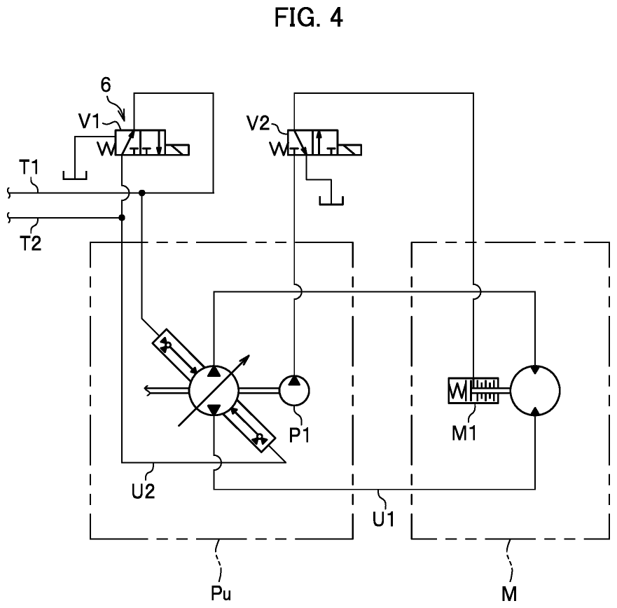

FIG. 4 is a schematic diagram of a hydraulic circuit of the rolling system including the brake device 6. A pump Pu for rolling driven by an engine (not illustrated) is connected to a motor M for rolling for rotating the tire drums 11 (FIG. 1) in series to form a hydraulic closed circuit U1. The pump Pu for rolling is a swash plate type pump. The pump Pu for rolling is connected to a hydraulic passage T1 and a hydraulic passage T2 for actuating a swash plate. A two-position three-port solenoid valve V1 is provided between the hydraulic passage T1 and the hydraulic passage T2, in parallel with the pump Pu for rolling.

When the engine is running, the solenoid valve V1 is in the right position in FIG. 4 so that the hydraulic passage T1 is not communicated with the hydraulic passage T2. Accordingly, in the case that the engine is running, when a forward/rearward lever (not illustrated) installed in a driver seat is tilted to a forward position, the hydraulic oil for actuating the swash plate flows from the hydraulic passage T1 to the hydraulic passage T2, which causes the swash plate to be tilted toward one side. As a result, pressure oil flows toward one direction in the closed circuit U1, and the motor M for rolling rotates in one direction to move the construction vehicle 10 (FIGS. 1 and 2) forward. On the other hand, when the forward/rearward lever is tilted to a rearward position, the hydraulic oil for actuating the swash plate flows from the hydraulic passage T2 to the hydraulic passage T1, which causes the swash plate to be tilted toward the other side. As a result, the pressure oil flows toward the other direction in the closed circuit U1, and the motor M for rolling rotates in the other direction to move the construction vehicle 10 rearward.

When the engine is not running, the solenoid valve V1 is in the left position in FIG. 4 so that the hydraulic passage T1 is communicated with the hydraulic passage T2. A hydraulic closed circuit U2 is formed between the solenoid valve V1 and the pump Pu for rolling so that there is no difference in pressure between the hydraulic passage Ti and the hydraulic passage T2 to set the swash plate in a neutral position. Then, HST (Hydro Static Transmission) braking is activated in the closed circuit U1.

The brake device 6 employs the solenoid valve V1. Therefore, when detecting the obstacle G while the vehicle is moving rearward, the operation controller 50 outputs a brake signal to switch the solenoid valve V1 from the right position to the left position. Accordingly, even when the engine is running and the forward/rearward lever (not illustrated) remains to be tilted to the rearward position, the swash plate is in the neutral position, which activates the HST braking to stop the motor M for rolling. Note that an electromagnetic valve V2, which activates a negative brake M1 while parking, is provided between a charge pump P1 installed in the pump Pu for rolling and the negative brake M1 installed in the motor M for rolling.

When the obstacle G is detected, the brake device 6 is controlled to avoid the construction vehicle 1 from colliding with the obstacle G. Especially, if the construction vehicle 10 is stopped by braking without turning off the engine (not illustrated), there is no need to restart the engine when operation is restarted. Further, a compactor having the tire drums 11 or the like employs an HST brake as the brake device 6 to avoid excessive sudden stop, as compared with a case where the engine is turned off. Accordingly, poor flatness such as dents in a road surface of an asphalt pavement is reduced. Further, rolling operation is easily restarted.

Note that, instead of the brake device 6, an alarm (not illustrated) by sound or light may be provided. Further, the brake device 6 and the alarm may be used together. Still further, the distance image sensor 2 may be attached to a front of the construction vehicle 10 for detecting obstacles in a forward moving direction of the construction vehicle 10.

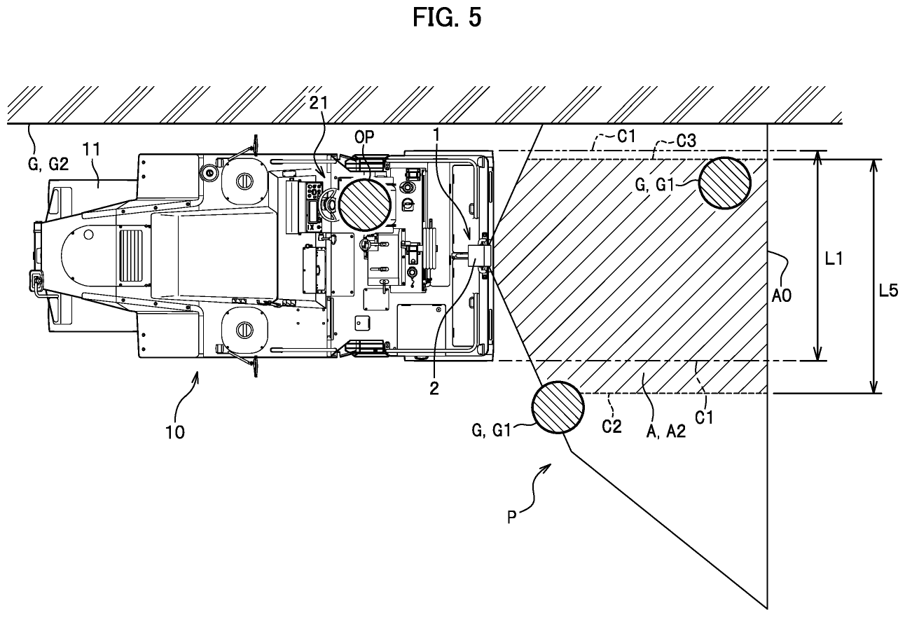

Returning to FIG. 3, the operation controller 50 alters the obstacle detection range A based on operation of the operating device 21 by the operator OP (FIGS. 1 and 2). In the first embodiment, the operation controller 50 alters the normal detection range Al (FIG. 1) to the altered detection range A2 (FIG. 5), in which a portion of the normal detection range A1 closer to the wall G2 as an example of the obstacle G is altered as a non-detected area.

The operation controller 50 includes a trigger detection unit 51, an alteration unit 52, an obstacle detection unit 53, a control unit 54, and a detection range database (DB) 55.

The trigger detection unit 51 detects an alteration trigger as a trigger to alter the obstacle detection range A in the width direction of the construction vehicle 10 (FIGS. 1 and 2). The alteration trigger includes predetermined operations on the operating device 21 by the operator OP of the construction vehicle 10. The alteration trigger includes the predetermined operations by the operator OP so that the operator OP can operate the operating device 21 at an arbitrary timing based on a driving situation of the construction vehicle 10 to alter the obstacle detection range A at an appropriate timing.

The predetermined operations by the operator OP, though which are not illustrated, includes pressing two buttons displayed on a touch display or the like, switching right to left or left to right with a 3P toggle switch, pressing two push switches provided on a right side and a left side, and operating switches respectively provided on forward/rearward levers on the right and left sides, for example. Though not illustrated, in a case where two buttons are displayed side by side on the display, for example, when the button displayed on the left side is pressed, a left end (left boundary line C2 in FIG. 1) of the obstacle detection range A of the construction vehicle 10 is altered. Likewise, when the button displayed on the right side is pressed, a right end (right boundary line C2 in FIG. 1) of the obstacle detection range A of the construction vehicle 10 is altered. Note that the configuration of the buttons is merely an example and may be formed with one button or three buttons or more, for example.

When detecting an alteration trigger during operation with the normal detection range A1 as the obstacle detection range A during normal operation, the alteration unit 52 alters the normal detection range A1 to the predetermined altered detection range A2 as the obstacle detection range A when altered. The altered detection range A2 is a detection range to be set when the construction vehicle 10 is pulled over to a structure such as the wall G2, for example. The alteration of the obstacle detection range A is described with reference to FIG. 5.

FIG. 5 is a plan view of the construction vehicle 10 detecting obstacles with the altered detection range A2. The altered detection range A2 is a range defined by, for example, the boundary line C2 and a boundary line C3 in the width direction, and a boundary line A0 at a rear end in the projection range P. The altered detection range A2 in FIG. 5 is altered from the normal detection range A1 illustrated in FIG. 1 by the operation of the operating device 21 by the operator OP. That is, in the example of FIG. 5, the operator OP recognizes presence of the wall G2 on the right side (one side in the width direction) of the construction vehicle 10, so that a position of the right end defining the obstacle detection range A is altered. Specifically, the right end defining the obstacle detection range A is altered from the right boundary line C2 (FIG.1) defining the normal detection range A1 (FIG. 1) to the right boundary line C3 defining the altered detection range A2. That is, the end of the altered detection range A2 closer to the wall G2 in the altered detection range A2 is set inside the virtual reference line C1 closer to the wall G2.

Meanwhile, an end of the altered detection range A2 on a side opposite to the wall G2 in the altered detection range A2 is the same as that of the normal detection range Al. That is, in the example of FIG. 5, the boundary line C2 in the width direction of the altered detection range A2 on the left side (other side in the width direction) of the construction vehicle 10 is the same as the left boundary line C2 (FIG. 1) of the normal detection range A1 (FIG. 1). That is, the boundary line C2 of the altered detection range A2 on the side opposite to the wall G2 is maintained without being altered from the normal detection range A1 even if the obstacle detection range A is altered.

The altered detection range A2 is set to be reduced in the width direction with respect to the normal detection range Al. In the example of FIG. 5, a dimension L5 in the width direction of the altered detection range A2 is shorter than the dimension L4 (FIG. 1). A distance (offset distance) X from the virtual reference line C1 closer to the wall G2 of the altered detection range A2 to the boundary line C3 may be appropriately set. The distance X is set to 0<X<50 (cm), for example. Accordingly, the person G1 working near the wall G2 is detected.

Note that in the embodiment described above, the wall G2 is present on the right side. In a case where the wall G2 is present on the left side, a position of the left end may be altered while a position of the right end defining the obstacle detection range A is maintained.

Returning to FIG. 3, the detection range DB 55 stores sizes of the normal detection range A1 and the altered detection range A2. Specifically, the detection range DB 55 stores analysis parameters with which the obstacle detection ranges A of the normal detection range A1 and the altered detection range A2 can be extracted from the measurement data of the distance image sensor 2. The alteration unit 52 obtains the obstacle detection range A based on the operation with the operating device 21 from the detection range DB 55, to detect the obstacle G present in the obtained obstacle detection range A.

The obstacle detection unit 53 detects the obstacle G present in the obstacle detection range A based on the data obtained from the distance image sensor 2. Specifically, the obstacle G is detected by the method described with reference to FIGS. 1 and 2.

The control unit 54 controls the brake device 6 when the obstacle G present in the obstacle detection range A is detected by the obstacle detection unit 53. The control over the brake device 6 at the time of detecting the obstacle G forcibly stops the operation of the construction vehicle 10 (FIG. 1). This prevents the obstacle G from being caught in the construction vehicle 10. Specifically, the brake device 6 is controlled by the method described with reference to FIG. 4.

Though not illustrated, the operation controller 50 includes a Central Processing Unit (CPU), a Random Access Memory (RAM), a Read Only Memory (ROM), a Hard Disk Drive (HDD), an interface (I/F), and the like, for example. The operation controller 50 is implemented by the CPU executing predetermined control programs stored in the ROM, RAM, or the like.

Next, a description is given of the obstacle detector 1 according to the present embodiment, with comparison between the normal detection range A1 and the altered detection range A2. When the alteration trigger such as operation with the operating device 21 is detected, the obstacle detector 1 alters the obstacle detection range A from the normal detection range A1 to the altered detection range A2. This allows for altering the obstacle detection range A in accordance with a driving condition of the construction vehicle 10 (FIG. 1) and circumstances in the vicinity of the construction vehicle 10. Accordingly, false detection of the obstacle G with the obstacle detection range A and excessive detection in the vicinity of the construction vehicle 10 are reduced, to prevent unintended detection of obstacle G. Thus, it is possible to prevent the construction vehicle 10 from being stopped due to false detection and excessive detection, to improve operability and construction efficiency of the construction vehicle 10.

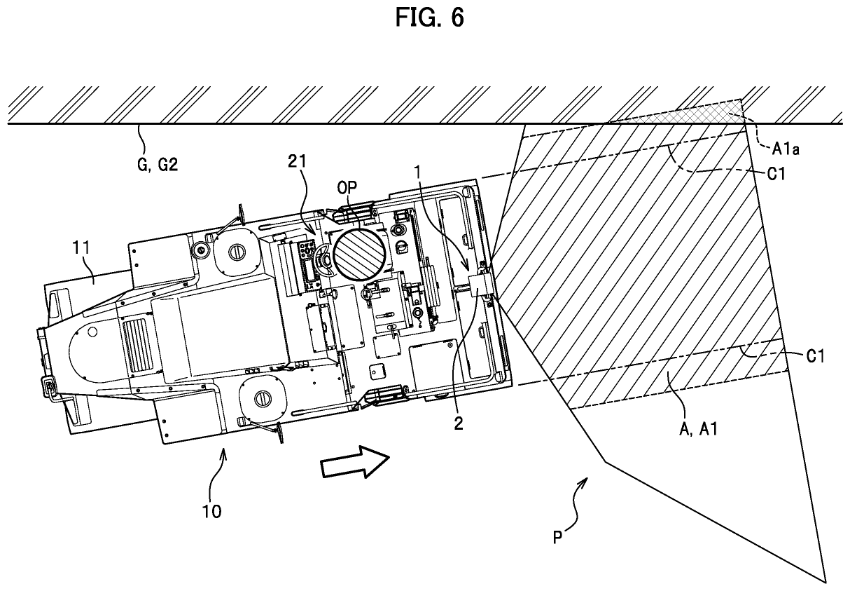

FIG. 6 is a diagram for illustrating detection in the normal detection range A1 when the construction vehicle 10 is pulled over to the wall. As illustrated by an outlined arrow, when the construction vehicle 10 is moved backward to be pulled over to the wall G2, the wall G2 is included in an area A1a at a rear end of the normal detection range A1 on a side closer to the wall G2. Accordingly, the obstacle detection unit 53 (FIG. 3) detects the obstacle G present in the normal detection range A1 so that the construction vehicle 10 is forcibly stopped by control over the brake device 6. This causes problems such that construction in the vicinity of the wall G2 is insufficient and construction efficiency is reduced, though the construction vehicle 10 can be further pulled over to the wall G2.

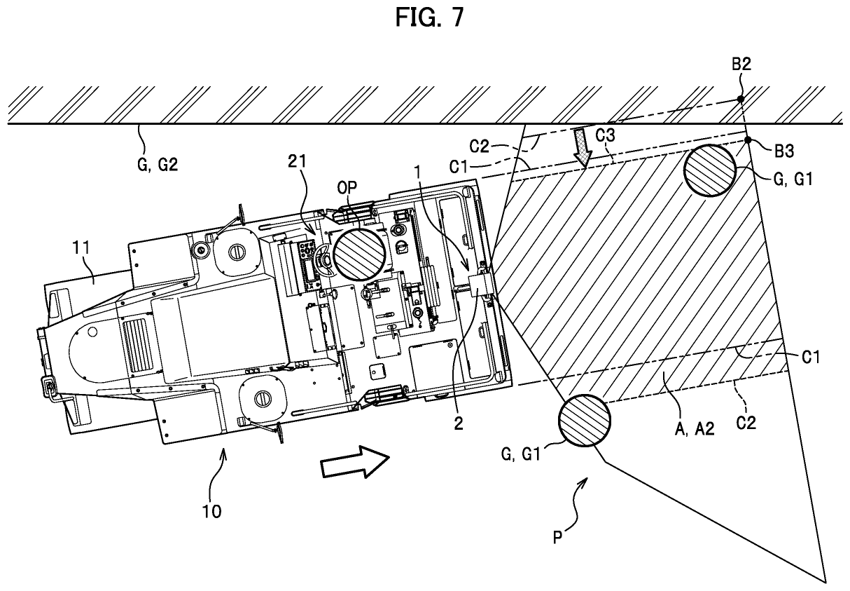

FIG. 7 illustrates detection in the altered detection range A2 when the construction vehicle 10 is pulled over to the wall. As described above, when an alteration trigger such as operation with the operating device 21 is detected, the obstacle detection range A is changed from the normal detection range A1 to the altered detection range A2. In the example of FIG. 7, the boundary line of the obstacle detection range A on the side closer to the wall G2, which is the obstacle G, is altered from the boundary line C2 defining the normal detection range A1 to the boundary line C3 defining the altered detection range A2, as illustrated by a hatched arrow.

The obstacle detection range A on the side closer to the wall G2 is reduced in the width direction with respect to the normal detection range A1 to have the wall G2 excluded in the altered detection range A2. That is, in the plan view, with the alteration to the altered detection range A2, a corner B2 which is the closest to the wall G2 in the normal detection range A1 (FIG. 6) does not overlap with the wall G2. Accordingly, the obstacle detection unit 53 (FIG. 3) does not detect the wall G2 so that the construction vehicle 10 is prevented from being stopped.

Further, the end of the altered detection range A2 on the side closer to the wall G2 is set inside the virtual reference line C1 on the side closer to the wall G2 so that the construction vehicle 10 is operated at a position as close as possible with respect to the wall G2. This allows the construction vehicle 10 to be sufficiently pulled over to the wall G2 so as to continuously perform construction in the vicinity of the wall G2.

Further, a distance to be reduced from the boundary line C2 to the boundary line C3 may be appropriately set. For example, a distance X from the virtual reference line C1 to the boundary line C3 is set to 0<X<50 (cm), to allow for detecting an obstacle (person G1 for example) in the vicinity of the wall G2. That is, detectability for the obstacle G is maintained while a decrease in construction efficiency is prevented.

Still further, the boundary line C2 of the altered detection range A2 is set to be the same as the boundary line C2 of the normal detection range A1 on the side opposite to the wall G2, so that the obstacle detection range A on the side opposite to the wall G2 is maintained outside the virtual reference line C1. Therefore, another obstacle G (person G1 in FIG. 7) on the side opposite to the wall G2 is detected. That is, according to the present embodiment, detection ranges are respectively set on the side closer to the wall G2 and the side opposite to the wall G2, to improve construction efficiency while detectability on both sides of the construction vehicle 10 is suitably maintained.

### Second Embodiment

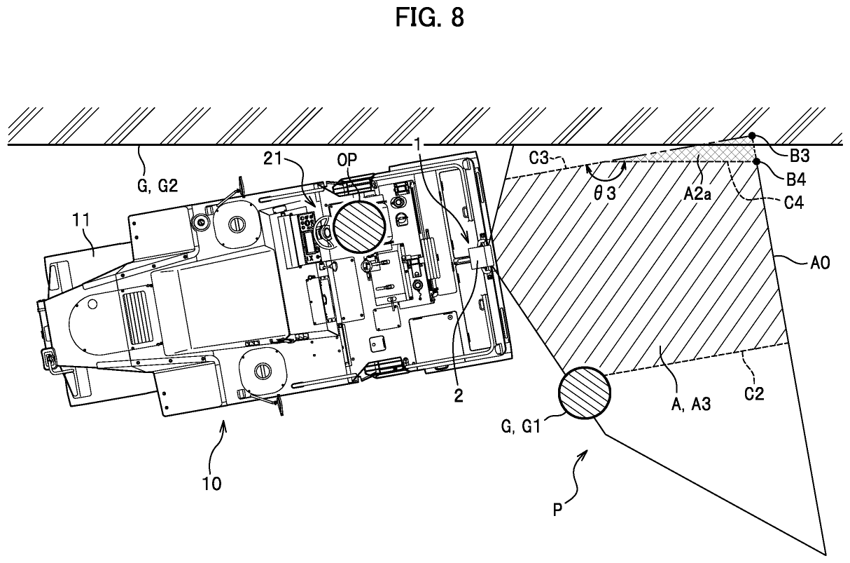

FIG. 8 is a plan view of the construction vehicle 10 of a second embodiment. The second embodiment is the same as the first embodiment except that an altered detection range A3 is stored in place of the altered detection range A2 stored in the detection range DB55 (see FIG. 3).

In the altered detection range A3, an area A2a including a corner B3, where a corner closer to the wall G2 is located on the rear side, is set as a non-detected area. In the altered detection range A3 illustrated in FIG. 8, the area A2a including the corner B3 in the altered detection range A2 (FIG. 5) is set as a non-detected area. Thus, the altered detection range A3 is a range of the projection range P defined by the boundary lines C2, C3, and C4 in the width direction, and a boundary line A0 at a rear end. An end of the altered detection range A3 closer to the wall G2 is defined by the boundary line C3 extending rearward of the construction vehicle 10 and the boundary line C4 intersecting the boundary line C3 at an angle θ3 and extending along the wall G2. The side including the corner B3 with respect to the boundary line C4, that is, the area A2a closer to the wall G2 is set as a non-detected area. An intersection of the boundary line C4 and the boundary line A0 at the rear end of the altered detection range A3 is set as a point B4.

A size of the area A2a outside the obstacle detection range is determined based on the angle θ3 made by the boundary line C3 and boundary line C4, for example. The angle θ3 is determined based on an angle in a normal rearward movement direction of the construction vehicle 10 with respect to the wall G2 when the construction vehicle 10 is pulled over to the wall G2, for example. However, the altered detection range A3 merely needs to be set such that a corner is present on the rear side in the altered detection range A3, and an area including the corner closer to the wall G2 is set as a non-detected area. The altered detection range A3 is not necessarily set based on the altered detection range A2.

When the construction vehicle 10 is moving backward toward the wall G2, the obstacle detection range A is altered from the normal detection range A1 to the altered detection range A3. Therefore, the corner closer to the wall G2 of the altered detection range A2 (FIG. 5) is altered from the position of the corner B3 to the position of the point B4 which is located inner than the corner B3. Accordingly, even when the wall G2 were detected with the altered detection range A2, the wall G2 is not detected with the altered detection range A3. Consequently, it is possible to further prevent the construction vehicle 10 from being stopped unintentionally, and the construction vehicle 10 is sufficiently pulled over to the wall G2.

### Third Embodiment

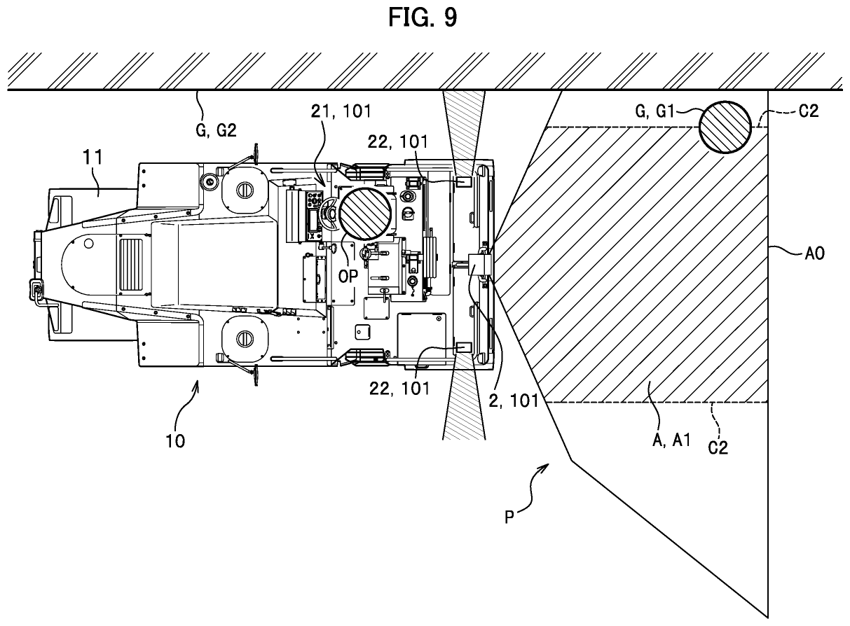

FIG. 9 is a plan view of the construction vehicle 10 mounted with obstacle detectors 101 of a third embodiment. The obstacle detectors 101 each further include a structure detection sensor 22 besides the obstacle detector 1 (FIG. 3). That is, the obstacle detector 101 includes the structure detection sensor 22 which detects the wall G2 (example of a structure) among obstacles. The alteration trigger described above includes detection of the wall G2 by the structure detection sensors 22.

The structure detection sensors 22 are mounted on the construction vehicle 10. The same type of a sensor as the distance image sensor 2 may be used for the structure detection sensor 22, for example. That is, when the structure detection sensors 22 laterally project light from both sides of the construction vehicle 10 and detect an object in a predetermined time within a predetermined distance in the longitudinal direction, the object is detected as the wall G2.

The alternation trigger for the obstacle detection range A includes detection of the wall G2 by the structure detection sensor 22. Therefore, when the wall G2 has been detected, the obstacle detection range A is altered from the normal detection range A1 to the altered detection range A2 (FIG. 5) or the altered detection range A3 (FIG. 8). The detection of the wall G2 by the structure detection sensor 22 is taken as an alteration trigger so that the obstacle detection range A is automatically altered without specific operation with the operating device 21 by the operator OP of the construction vehicle 10. Therefore, the construction vehicle 10 can be pulled over toward the wall G2 without a need by the operator OP more than necessary to check a gap between the wall G2 and the construction vehicle 10 while detection of the obstacle G is being performed with the altered detection range A2.

That is, according to the present embodiment, the dimension in the width direction of the normal detection range is equal to or more than the width of the construction vehicle 10, to allow for detecting the wall G2 present on an outer side in the width direction of the construction vehicle 10. Further, the altered detection ranges are set to be reduced in the width direction with respect to the normal detection range. Particularly, in the case where the lines extending rearward from the sides of the construction vehicle 10 so as to be in line with the sides are set as the virtual reference lines, the boundary line, on the side closer to the wall G2, of the altered detection range is set inside the virtual reference line. This allows the construction vehicle 10 to be pulled over to the wall G2. At the same time, the boundary line, on the side opposite to the wall G2, of the altered detection range is set to be the same as the boundary line in the width direction of the normal detection range. Accordingly, another structure can be detected on the side opposite to the wall G2, with the same detection accuracy at the time of setting the normal detection range.

Further, the altered detection range is set to have the area on the rear side, including the corner closer to the wall G2, as a non-detected area. This prevents the structure detection sensor 22 from detecting the wall G2, to facilitate the construction vehicle 10 being pulled over to the wall G2.

Note that the structure detection sensors 22 may be implemented with other configurations as long as they can detect fixed structures such as buildings, columns, curbs, fences, and movable structures such as movable walls, movable fences, and color cones (registered trademark). For example, the structure detection sensors 22 may employ image processers including an in-vehicle camera, an image determinator, and the like. The structure detection sensors extract an image characteristic of an object based on a video captured by the in-vehicle camera and determine matching with respect to a reference image, to detect a structure.

The embodiments of the present disclosure have been described above, but can be modified in design as appropriate within a range of the gist of the present disclosure. For example, in the present embodiment, the position of the boundary line on one side in the width direction is moved inward from the normal detection range, but the positions of the boundary lines on both sides may be moved inward. Further, in the present embodiment, the altered detection ranges are reduced in the width direction from the normal detection range, but the boundary line(s) on one side or both sides of the normal detection range may be moved outward (to expand the range) to set the altered detection range.

Note that, in the embodiments described above, the distance image sensor 2 (3D distance sensor) of a Time of Flight (TOF) type is used as an object detection sensor, which measures the distance to the object with use of projection and reflection, but the present disclosure is not limited thereto. The object detection sensor may be one of sensors such as an ultrasonic sensor, a microwave sensor, a laser light sensor, an infrared sensor, a radar sensor, a LiDAR sensor, a stereo camera sensor, and a monocular camera sensor which can detect objects within a predetermined range.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. An obstacle detector mounted on a construction vehicle to detect an obstacle, comprising:
an operation controller including:
a trigger detection unit which detects an alteration trigger as a trigger to alter an obstacle detection range in a width direction of the construction vehicle; and
an alteration unit which alters a normal detection range, which is the obstacle detection range during normal operation, to a predetermined altered detection range, which is an obstacle detection range after alteration, when the alteration trigger is detected at a time of operating with the normal detection range.

2. The obstacle detector of a construction vehicle as claimed in claim 1, wherein the alteration trigger includes predetermined operation with an operating device by an operator of the construction vehicle.

3. The obstacle detector of a construction vehicle as claimed in claim 2, wherein a dimension in the width direction of the normal detection range is equal to or more than a width of the construction vehicle.

4. The obstacle detector of a construction vehicle as claimed in claim 3, wherein the altered detection range is set to be reduced in the width direction with respect to the normal detection range.

5. The obstacle detector of a construction vehicle as claimed in claim 4, wherein, when lines extending rearward from sides of the construction vehicle so as to be in line with the sides are set as virtual reference lines, a boundary line on one side in the width direction of the altered detection range is set inside the virtual reference line.

6. The obstacle detector of a construction vehicle as claimed in claim 5, wherein a boundary line on the other side in the width direction of the altered detection range is set to be the same as a boundary line on the other side in the width direction of the normal detection range.

7. The obstacle detector of a construction vehicle as claimed in claim 5, wherein the altered detection range has an area on a rear side thereof, including a corner on the one side in the width direction, set as a non-detected area.

8. The obstacle detector of a construction vehicle as claimed in claim 1, further comprising a structure detection sensor which detects a structure among obstacles,
wherein the alteration trigger includes detection of the structure by the structure detection sensor.

9. The obstacle detector of a construction vehicle as claimed in claim 8, wherein a dimension in the width direction of the normal detection range is equal to or more than a width of the construction vehicle.

10. The obstacle detector of a construction vehicle as claimed in claim 9, wherein the altered detection range is set to be reduced in the width direction with respect to the normal detection range.

11. The obstacle detector of a construction vehicle as claimed in claim 10, wherein the structure detection sensor detects a structure, and
when lines extending rearward from sides of the construction vehicle so as to be in line with the sides are set as virtual reference lines, a boundary line of the altered detection range, on a side closer to the structure, is set inside the virtual reference line.

12. The obstacle detector of a construction vehicle as claimed in claim 11, wherein a boundary line of the altered detection range, on a side opposite to the structure, is set to be the same as a boundary line in the width direction of the normal detection range.

13. The obstacle detector of a construction vehicle as claimed in claim 8, wherein the altered detection range is set to have an area on a rear side thereof, including a corner of the structure, set as a non-detected area.

14. The obstacle detector of a construction vehicle as claimed in claim 6, wherein the altered detection range has an area on a rear side thereof, including a corner on the one side in the width direction, set as a non-detected area.

15. The obstacle detector of a construction vehicle as claimed in claim 9, wherein the altered detection range is set to have an area on a rear side thereof, including a corner of the structure, set as a non-detected area.

16. The obstacle detector of a construction vehicle as claimed in claim 10, wherein the altered detection range is set to have an area on a rear side thereof, including a corner of the structure, set as a non-detected area.

17. The obstacle detector of a construction vehicle as claimed in claim 11, wherein the altered detection range is set to have an area on a rear side thereof, including a corner of the structure, set as a non-detected area.

18. The obstacle detector of a construction vehicle as claimed in claim 12, wherein the altered detection range is set to have an area on a rear side thereof, including a corner of the structure, set as a non-detected area.
